(19) United States
(12) Patent Application Publication
(10) Pub. No.: US 2020/0312196 A1
(43) Pub. Date: Oct. 1, 2020

(54) SELF-LOCKING COLLAPSIBLE DISPLAY FRAME

(71) Applicant: Robert Hilsenroth, Fernandina Beach, FL (US)

(72) Inventor: Robert Hilsenroth, Fernandina Beach, FL (US)

(21) Appl. No.: 16/368,928

(22) Filed: Mar. 29, 2019

(51) Int. Cl. G09F 1/12; A47G 1/06

(52) U.S. Cl. CPC G09F 1/12; A47G 2001/0688; A47G 1/065

(57) ABSTRACT

A self-locking collapsible display frame is described. Some implementations can include a frame kit having a top frame piece, a bottom frame piece, a left side frame piece, a right side frame piece, a first planar member, and a second planar member. The frame includes slanted dovetail joints that become locked when the first and second planar members engage the frame pieces.

### TECHNICAL FIELD

Some implementations relate generally to display frames, and more particularly, to a self-locking collapsible display frame.

### BACKGROUND

Display frames may come preassembled, which can increase shipping volume and cost of the frame due to a need for assembly time and fasteners to hold the assembled display frame together. A need may exist for a self-locking collapsible display frame that can be assembled by a user and can self-lock without a need for fasteners, which may add cost or require special skill to install.

Some implementations were conceived in light of the above mentioned needs, among other things.

### BRIEF DESCRIPTION OF THE DRAWINGS

FIG. 1 is a diagram of an example self-locking collapsible display frame kit in accordance with some implementations.

FIG. 2 is a diagram of example self-locking collapsible display frame pieces in accordance with some implementations.

FIG. 3 is a diagram of an example joint of a self-locking collapsible display frame aligned for assembly in accordance with some implementations.

FIG. 4 is a diagram of the example joint of FIG. 3 in the assembled position accordance with some implementations.

FIG. 5 is a diagram of a partially assembled example self-locking collapsible display frame in accordance with some implementations.

FIG. 6 is a diagram of a partially assembled example self-locking collapsible display frame at stage of assembly subsequent to the stage of assembly shown in FIG. 5.

FIG. 7 is a diagram of a partially assembled example self-locking collapsible display frame at stage of assembly subsequent to the stage of assembly shown in FIG. 6.

FIG. 8 is a diagram of an assembled example self-locking collapsible display frame in accordance with some implementations.

### DETAILED DESCRIPTION

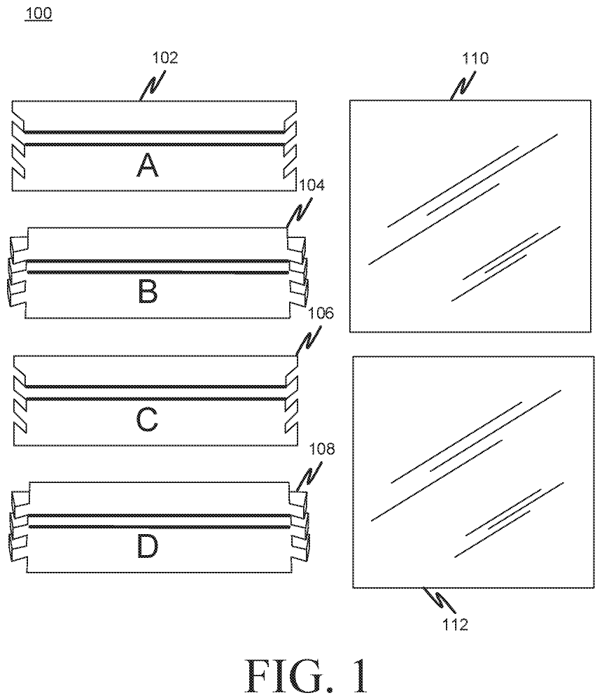

FIG. 1 is a diagram of an example self-locking collapsible display frame kit 100 in accordance with some implementations. The kit 100 includes a top frame piece 104 (or piece “B”), a bottom frame piece 108 (or piece “D”), a right side frame piece 106 (or piece “C), and a left side frame piece 102 (or piece “A”). The kit 100 also includes a first planar member 110 and a second planar member 112. The frame pieces (102-108) can be made from wood, plastic, metal, or any other suitable display frame material or combination of materials. The first and second planar members (110-112) can be both be made from a clear material such as clear plastic or glass, or one of the planar members can be made from a clear material and one can be made from an opaque material (e.g., as a backing material). Each of the frame pieces has a bottom groove and a top groove formed into an interior of the frame piece. The bottom and top grooves are formed on each piece so that, when the frame pieces are assembled, the bottom and top grooves can accommodate the first planar member 110 and the second planar member 112, respectively.

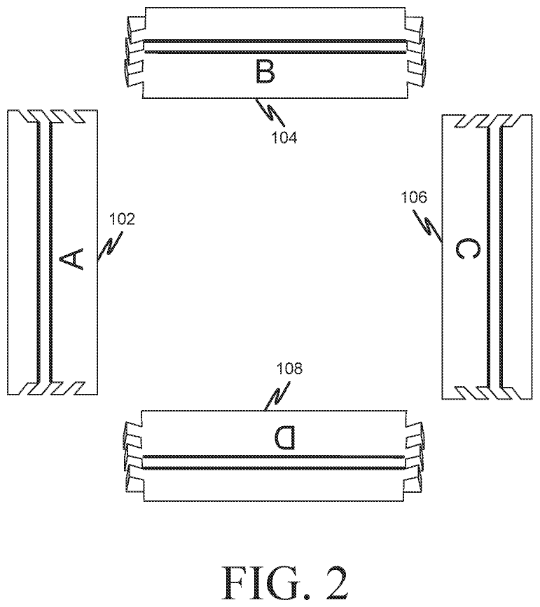

FIG. 2 is a diagram of example self-locking collapsible display frame pieces in accordance with some implementations. In particular, FIG. 2 shows the frame pieces (102-108) arranged for assembly.

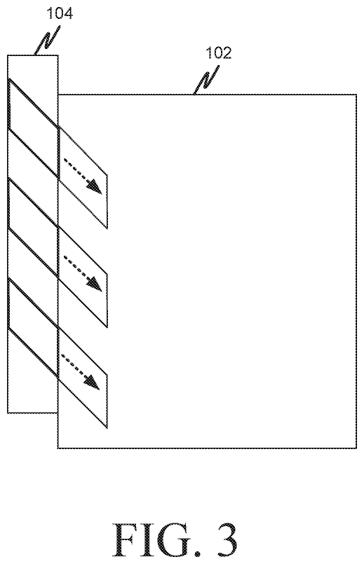

FIG. 3 is a diagram of an example joint of a self-locking collapsible display frame aligned for assembly in accordance with some implementations. The joint shown in FIG. 3 is the joint where the top frame piece 104 meets the left side frame piece 102. The top frame piece 104 is slightly elevated relative to the left side frame piece 104. The top frame piece 104 includes slanted finger joint member designed to engage corresponding recesses in the left side frame piece 102 when the top frame piece 104 is moved in a downward and inward direction relative to the left side frame piece 102 (as shown by the dotted line arrows in FIG. 3).

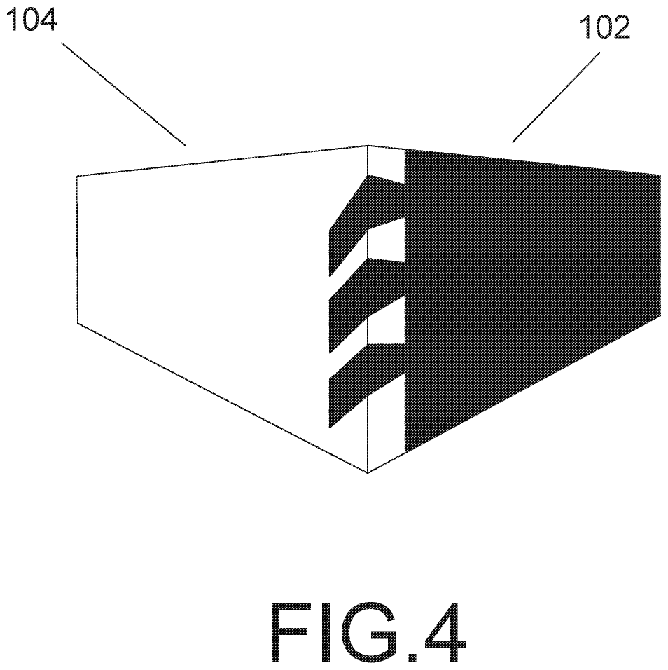

FIG. 4 is a diagram of the example joint of FIG. 3 in the assembled position accordance with some implementations. In FIG. 4, the top frame piece 104 has engaged the left side frame piece 102 and the respective slanted finger joint members have engaged each other. FIG. 4 shows detail of the slanted dovetail construction of the corner joints in accordance with some implementations. The slanted dovetail construction prevents the corner joint from separating along a first axis or in a first direction (e.g., 104 pulling away from 102 due to the dovetail) and the combination of the slanted dovetail joint elements and the planar members (discussed below) prevent the joint from separating along a second axis or in a second direction (e.g., 102 pulling away from 104).

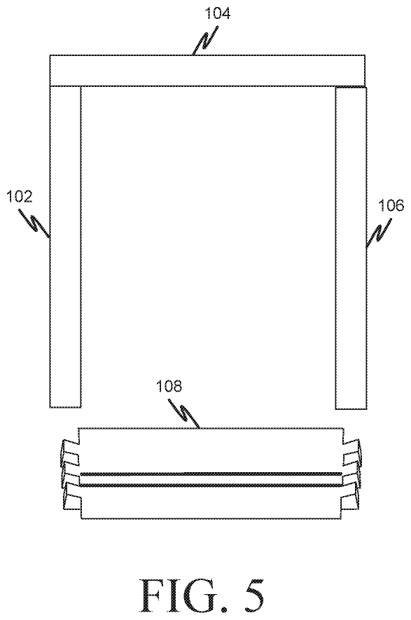

FIG. 5 is a diagram of a partially assembled example self-locking collapsible display frame in accordance with some implementations. As shown in FIG. 5, the left side frame piece 102 has engaged the top frame piece 104, which has also engaged the right side frame piece 106. The bottom frame piece 108 is the remaining frame piece to be assembled onto the frame.

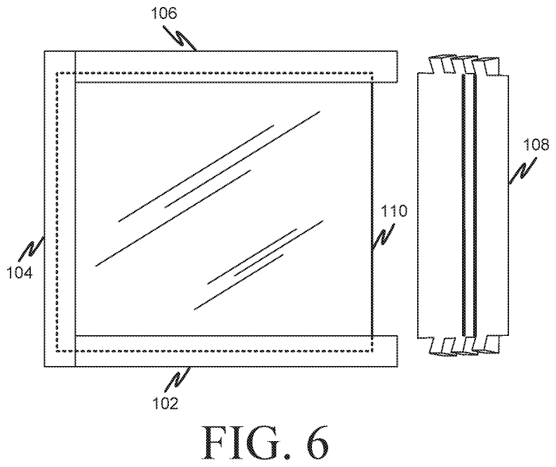

FIG. 6 is a diagram of a partially assembled example self-locking collapsible display frame at stage of assembly subsequent to the stage of assembly shown in FIG. 5. In the stage of assembly shown in FIG. 6, a first planar member 110 has been inserted into the bottom grooves of the left side frame piece 102, top frame piece 104, and right side frame piece 106.

Once the first planar member has been inserted, the item for display can be placed on top of the first planar member 110. The item for display can include a photograph, a picture, artwork, a puzzle, or, in general, anything that can fit within the first and second planar members when those members are inserted into respective grooves within the frame pieces.

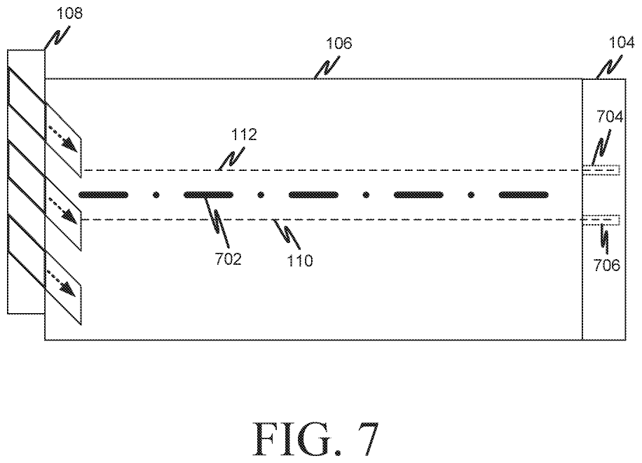

FIG. 7 is a diagram of a partially assembled example self-locking collapsible display frame at stage of assembly subsequent to the stage of assembly shown in FIG. 6. At the stage shown in FIG. 7, an item for display 702 has been placed on top of the first planar member 110, and a second planar member 112 has been inserted into the frame. The first planar member 110 extends into a top frame piece first planar member slot 706. The second planar member 112 extends into a top frame piece first planar member slot 704. The bottom frame piece 108 is positioned for assembly onto the frame.

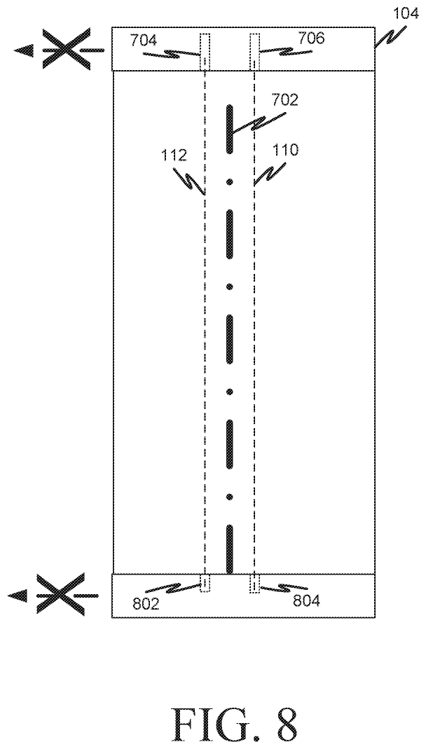

FIG. 8 is a diagram of an assembled example self-locking collapsible display frame in accordance with some implementations. Once the self-locking collapsible frame is upright as shown in FIG. 8, the first and second planar members are able to slide downward (toward the bottom frame piece 108) respectively into a bottom frame piece first planar member slot 804 and a bottom frame piece second planar member slot 802 such that a respective portion of the first and second planar members extends into each of the top frame piece first planar member slot 706, the top frame piece second planar member slot 704, the bottom frame piece first planar member slot 804, and the bottom frame piece second planar member slot 802.

The top frame piece first planar member slot 706 and the top frame piece second planar member slot 704 are deeper than the bottom frame piece first planar member slot 804 and a bottom frame piece second planar member slot 802. For example, the top frame piece planar member slots (704, 706) may have double the depth of the bottom frame piece planar member slots (802, 804). The difference in depth permits the planar members to be inserted into the top frame piece slots during assembly so that the planar members are moved out of the way of the bottom frame piece as it is being engaged with the two side frame pieces. Once the bottom frame piece is fully engaged with the side frame pieces, the first and second planar members can be permitted to slide from the top frame piece planar member slots to enable a portion of the bottom of the planar members to extend into the bottom frame piece planar member slots.

By having a portion of the first and second planar members extending into the top and bottom frame piece planar member slots, the top and bottom frame pieces are prevented from moving in a perpendicular direction relative to the side frame pieces (as shown by the crossed out dashed arrows in FIG. 8) and thus the display frame becomes self-locking. In order to collapse the display frame, the frame can be placed in a horizontal orientation (e.g., as shown in FIG. 7) and the first and second planar members can be slide from the bottom frame piece planar member slots into the top frame piece planar member slots in order to permit the bottom frame piece to be removed from the assembled frame. Once the bottom frame piece has been removed, the planar members and the display item can be removed. Once the planar members are removed, the top frame piece can be disassembled from the side frame pieces, and the frame is collapsed into individual pieces.

It is, therefore, apparent that there is provided, in accordance with the various embodiments disclosed herein, a self-locking collapsible display frame.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A display frame kit comprising:
a top frame piece having a first top frame piece end, a second top frame piece end, a first top frame piece planar member slot, and a second top frame piece planar member slot;
a bottom frame piece having a first bottom frame piece end, a second bottom frame piece end, a first bottom frame piece planar member slot, and a second bottom frame piece planar member slot;
a left side frame piece having a first left side frame piece end, a second left side frame piece end, a first left side frame piece planar member slot, and a second left side frame piece planar member slot;
a right side frame piece having a first right side frame piece end, a second right side frame piece end, a first right side frame piece planar member slot, and a second right side frame piece planar member slot;
a first planar member; and
a second planar member,
wherein the first left side frame piece end and the second left side frame piece end are configured to engage the first top frame piece end and the first bottom frame piece end, respectively in a slanted dovetail joint,
wherein the first right side frame piece end and the second right side frame piece end are configured to engage the second top frame piece end and the second bottom frame piece end, respectively in a slanted dovetail joint, and
wherein the a first top frame piece planar member slot and the second top frame piece planar member slot have a depth that is larger than a depth of the first bottom frame piece planar member slot and the second bottom frame piece planar member slot, respectively.
